(19) United States
(12) Patent Application Publication
(10) Pub. No.: US 2017/0107396 A1
(43) Pub. Date: Apr. 20, 2017

(54) PROCESS FOR ADDITIVE MANUFACTURING

(71) Applicant: SABIC Global Technologies B.V., Bergen op Zoom (NL)

(72) Inventors: Satish Kumar Gaggar, Hoover, AL (US); Malvika Bihari, Evansville, IN (US)

(21) Appl. No.: 15/317,300

(22) PCT Filed: May 6, 2015
(86) PCT No.: PCT/US2015/029419

§ 371 Date: Dec. 8, 2016

Related U.S. Application Data
(60) Provisional application No. 62/012,597, filed on Jun. 16, 2014.

(51) Int. Cl. C09D 133/20; B29C 67/00; B33Y 70/00; B33Y 10/00; C09D 125/12; C09D 125/14

(52) U.S. Cl. CPC C09D 133/20; C09D 125/12; C09D 125/14; B33Y 70/00; B33Y 10/00; B29C 67/0055

(57) ABSTRACT

A method of making a thermoplastic article comprising depositing a multitude of layers of thermoplastic extruded material in a preset pattern and fusing the multitude of layers of extruded material to form the article wherein the thermoplastic extraded material comprises a discontinuous elastomeric phase dispersed in a rigid thermoplastic phase wherein at the rigid thermoplastic phase comprises structural units derived from (C₁-C₁₂)alkyl(meth)acrylate.

### BACKGROUND

Additive Manufacturing (AM) is a new production technology that is transforming the way all sorts of things are made. AM makes three-dimensional (3D) solid objects of virtually any shape from a digital model. Generally, this is achieved by creating a digital blueprint of a desired solid object with computer-aided design (CAD) modeling software and then slicing that virtual blueprint into very small digital cross-sections. These cross-sections are formed or deposited in a sequential layering process in an AM machine to create the 3D object. AM has many advantages, including dramatically reducing the time from design to prototyping to commercial product. Running design changes are possible. Multiple parts can be built in a single assembly. No tooling is required. Minimal energy is needed to make these 3D solid objects. It also decreases the amount of waste and raw materials. AM also facilitates production of extremely complex geometrical parts. AM also reduces the parts inventory for a business since parts can be quickly made on-demand and on-site.

Material Extrusion (a type of AM) can be used as a low capital forming process for producing plastic parts, and/or forming process for difficult geometries. Material Extrusion involves an extrusion-based additive manufacturing system that is used to build a three-dimensional (3D) model from a digital representation of the 3D model in a layer-by-layer manner by selectively dispensing a flowable material through a nozzle or orifice. After the material is extruded, it is then deposited as a sequence of roads on a substrate in an x-y plane. The extruded modeling material fuses to previously deposited modeling material, and solidifies upon a drop in temperature. The position of the extrusion head relative to the substrate is then incremented along a z-axis (perpendicular to the x-y plane), and the process is then repeated to form a 3D model resembling the digital representation.

Material Extrusion can be used to make final production parts, fixtures and molds as well as to make prototype models for a wide variety of products. However, the strength of the parts in the build direction is limited by the bond strength and effective bonding surface area between subsequent layers of the build. These factors are limited for two reasons. First, each layer is a separate melt stream. Thus, the polymer chains of a new layer were not able to easily comingle with those of the antecedent layer. Secondly, because the previous layer has cooled, it must rely on conduction of heat from the new layer and any inherent cohesive properties of the material for bonding to occur. The reduced adhesion between layers also results in a highly stratified surface finish.

Accordingly, a need exists for an AM process capable of producing parts with improved aesthetic qualities and structural properties.

### BRIEF DESCRIPTION

Described herein is a method of making a thermoplastic article comprising depositing a multitude of layers of thermoplastic extruded material in a preset pattern and fusing the multitude of layers of extruded material to form the article wherein the thermoplastic extruded material comprises a discontinuous elastomeric phase dispersed in a rigid thermoplastic phase wherein the rigid thermoplastic phase has structural units derived from (C₁-C₁₂)alkyl(meth)acrylate and the thermoplastic extruded material further comprises at least 5 weight percent, based on the total weight of the thermoplastic extruded material, of a graft copolymer derived from the rigid thermoplastic phase and the elastomeric phase.

The above described and other features are exemplified by the following detailed description.

### BRIEF DESCRIPTION OF DRAWINGS

FIG. 1 shows data from the examples.

### DETAILED DESCRIPTION

Disclosed herein are additive manufacturing methods capable of producing parts with increased bonding between adjacent layers. Without being bound by theory, it is believed that the favorable results obtained herein, e.g., high strength three dimensional polymeric components, can be achieved through choosing the composition of the rigid thermoplastic phase. It is further believed that by appropriately choosing the glass transition temperature of the rigid thermoplastic phase, the subsequently deposited extruded material has the necessary melt characteristics to adhere to the previously deposited extruded material, thus increasing adhesion in all directions. Choosing a rigid thermoplastic phase which has structural units derived from (C₁-C₁₂)alkyl(meth)acrylate allows for a material with a more appropriate glass transition temperature for the matrix of the thermoplastic material. In addition, an increase bonding between layers can overcome some surface tension between layers resulting in cohesion which can enable improved surface quality of parts. Accordingly, parts with superior mechanical and aesthetic properties can be manufactured.

The term “material extrusion additive manufacturing technique” as used in the specification and claims means that the article of manufacture can be made by any additive manufacturing technique that makes a three-dimensional solid object of any shape by laying down material in layers from a thermoplastic material such as string of pellets or filament from a digital model by selectively dispensing through a nozzle or orifice.. For example, the extruded material can be made by laying down a plastic filament or string of pellets that is unwound from a coil or is deposited from an extrusion head. These additive manufacturing techniques include fused deposition modeling and fused filament fabrication as well as other material extrusion technologies as defined by ASTM F2792-12a.

The term “Material Extrusion” involves building a part or article layer-by-layer by heating thermoplastic material to a semi-liquid state and extruding it according to computer-controlled paths. Material extrusion can utilize a modeling material with or without a support material. The modeling material creates the finished piece, and the support material creates scaffolding that can be mechanically removed, washed away or dissolved when the process is complete. The process involves depositing material to complete each layer before the base moves down the Z-axis and the next layer begins.

Materials for use as the elastomeric phase are elastomers having a glass transition temperature less than or equal to 0° C. The elastomer may be naturally occurring or synthetic. These materials include, for example, natural rubber latex, natural rubber, conjugated diene rubbers; copolymers of a conjugated diene with less than or equal to 50 wt % of a copolymerizable monomer; olefin rubbers such as ethylene propylene copolymers (EPR) or ethylene-propylene-diene monomer rubbers (EPDM); ethylene-vinyl acetate rubbers; silicone rubbers; elastomeric C₁₋₈ alkyl (meth)acrylates; elastomeric copolymers of C₁₋₈ alkyl (meth)acrylates with butadiene and/or styrene; or combinations comprising at least one of the foregoing elastomers.

Conjugated diene monomers for preparing the elastomer phase include those of formula (17)

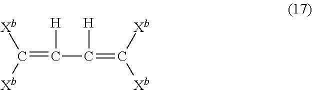

wherein each X^{b} is independently hydrogen, C₁-C₅ alkyl, or the like. Examples of conjugated diene monomers that can be used are butadiene, isoprene, 1,3-heptadiene, methyl-1,3-pentadiene, 2,3-dimethyl-1,3-butadiene, 2-ethyl-1,3-pentadiene; 1,3- and 2,4-hexadienes, and the like, as well as combinations comprising at least one of the foregoing conjugated diene monomers. Specific conjugated diene homopolymers include polybutadiene and polyisoprene.

Copolymers of a conjugated diene rubber can also be used, for example those produced by aqueous radical emulsion polymerization of a conjugated diene and at least one monomer copolymerizable therewith. Monomers that are useful for copolymerization with the conjugated diene include monovinylaromatic monomers containing condensed aromatic ring structures, such as vinyl naphthalene, vinyl anthracene, and the like, or monomers of formula (18)

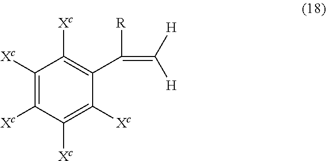

wherein each X^{c} is independently hydrogen, C₁-C₁₂ alkyl, C₃-C₁₂ cycloalkyl, C₆-C₁₂ aryl, C₇-C₁₂ aralkyl, C₇-C₁₂ alkylaryl, C₁-C₁₂ alkoxy, C₃-C₁₂ aryloxy, chloro, cycloalkoxy, C₆-C₁₂ bromo, or hydroxy, and R is hydrogen, C₁-C₅ alkyl, bromo, or chloro, monovinylaromatic monomers that can be used include styrene, 3-methylstyrene, 3,5-diethylstyrene, 4-n-propylstyrene, alpha-methylstyrene, alpha-methyl vinyltoluene, alpha-chlorostyrene, alpha-bromostyrene, dichlorostyrene, dibromostyrene, tetra-chlorostyrene, and the like, and combinations comprising at least one of the foregoing compounds. Styrene and/or alpha-methylstyrene can be used as monomers copolymerizable with the conjugated diene monomer.

Other monomers that can be copolymerized with the conjugated diene are monovinylic monomers such as itaconic acid, acrylamide, N-substituted acrylamide or methacrylamide, maleic anhydride, maleimide, N-alkyl-, aryl-, or haloaryl-substituted maleimide, glycidyl (meth)acrylates, and monomers of the generic formula (19)

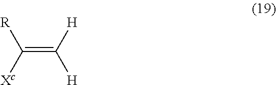

wherein R is hydrogen, C₁-C₅ alkyl, bromo, or chloro, and X^{c} is cyano, C₁-C₁₂ alkoxycarbonyl, C₁-C₁₂ aryloxycarbonyl, hydroxy carbonyl, or the like. Examples of monomers of formula (19) include acrylonitrile, methacrylonitrile, alpha-chloroacrylonitrile, beta-chloroacrylonitrile, alpha-bromoacrylonitrile, acrylic acid, methyl (meth)acrylate, ethyl (meth)acrylate, n-butyl (meth)acrylate, t-butyl (meth)acrylate, n-propyl (meth)acrylate, isopropyl (meth)acrylate, 2-ethylhexyl (meth)acrylate, and the like, and combinations comprising at least one of the foregoing monomers. Monomers such as n-butyl acrylate, ethyl acrylate, and 2-ethylhexyl acrylate are commonly used as monomers copolymerizable with the conjugated diene monomer. Combinations of the foregoing monovinyl monomers and monovinylaromatic monomers can also be used.

(Meth)acrylate monomers for use in the elastomeric phase can be cross-linked, particulate emulsion homopolymers or copolymers of C₁₋₈ alkyl (meth)acrylates, in particular C₄₋₆ alkyl acrylates, for example n-butyl acrylate, t-butyl acrylate, n-propyl acrylate, isopropyl acrylate, 2-ethylhexyl acrylate, and the like, and combinations comprising at least one of the foregoing monomers. The C₁₋₈ alkyl (meth)acrylate monomers can optionally be polymerized in admixture with less than or equal to 15 wt % of comonomers of formulas (17), (18), or (19), based on the total monomer weight. Comonomers include but are not limited to butadiene, isoprene, styrene, methyl methacrylate, phenyl methacrylate, phenethylmethacrylate, N-cyclohexylacrylamide, vinyl methyl ether or acrylonitrile, and combinations comprising at least one of the foregoing comonomers. Optionally, less than or equal to 5 wt % of a polyfunctional crosslinking comonomer can be present, based on the total monomer weight. Such polyfunctional crosslinking comonomers can include, for example, divinylbenzene, alkylenediol di(meth)acrylates such as glycol bisacrylate, alkylenetriol tri(meth)acrylates, polyester di(meth)acrylates, bisacrylamides, triallyl cyanurate, triallyl isocyanurate, allyl (meth)acrylate, diallyl maleate, diallyl fumarate, diallyl adipate, triallyl esters of citric acid, triallyl esters of phosphoric acid, and the like, as well as combinations comprising at least one of the foregoing crosslinking agents.

The elastomeric phase can be polymerized by mass, emulsion, suspension, solution or combined processes such as bulk-suspension, emulsion-bulk, bulk-solution or other techniques, using continuous, semi-batch, or batch processes. The particle size of the elastomer substrate is not critical. For example, an average particle size of 0.001 to 25 micrometers, specifically 0.01 to 15 micrometers, or even more specifically 0.1 to 8 micrometers can be used for emulsion based polymerized rubber lattices. A particle size of 0.5 to 10 micrometers, specifically 0.6 to 1.5 micrometers can be used for bulk polymerized rubber substrates. Particle size can be measured by simple light transmission methods or capillary hydrodynamic chromatography (CHDF). The elastomer phase can be a particulate, moderately cross-linked conjugated butadiene or C₄₋₆ alkyl acrylate rubber, and specifically has a gel content greater than 70%. Also useful are combinations of butadiene with styrene and/or C₄₋₆ alkyl acrylate rubbers.

The discontinuous elastomeric phase is present in an amount of 10 to 35 weight percent (wt %), based on the total weight of the thermoplastic material. Within this range the amount of the discontinuous elastomeric phase can be greater than or equal to 15 wt %, or greater than or equal to 15 wt %. Also within this range the amount of discontinuous elastomeric phase can be less than or equal to 30 wt %.

The rigid thermoplastic phase is formed from monomers that are polymerized in the presence of the elastomeric phase. At least a portion of the rigid thermoplastic phase is chemically grafted to the elastomeric phase, thus forming the graft copolymer. The rigid thermoplastic phase comprises a thermoplastic polymer or copolymer that exhibits a glass transition temperature of 25 to 105° C. Within this range the glass transition temperature can be greater than or equal to 75° C.

The rigid thermoplastic phase comprises a polymer having structural units derived from one or more monomers selected from the group consisting of (C₁-C₁₂)alkyl(meth)acrylate monomers, vinyl aromatic monomers and monoethylenically unsaturated nitrile monomers. As used herein, the terminology “(Cₓ-C_{y})”, as applied to a particular unit, such as, for example, a chemical compound or a chemical substituent group, means having a carbon atom content of from “x” carbon atoms to “y” carbon atoms per such unit. For example, “(C₁-C₁₂)alkyl” means a straight chain, branched or cyclic alkyl substituent group having from 1 to 12 carbon atoms per group and includes, but is not limited to, methyl, ethyl, n-propyl, iso-propyl, n-butyl, sec-butyl, t-butyl, pentyl, hexyl, heptyl, octyl, nonyl, decyl, undecyl and dodecyl. Suitable (C₁-C₁₂)alkyl(meth)acrylate monomers include, but are not limited to, (C₁-C₁₂)alkyl acrylate monomers, illustrative examples of which include ethyl acrylate, butyl acrylate, iso-pentyl acrylate, n-hexyl acrylate, and 2-ethyl hexyl acrylate; and their (C₁-C₁₂)alkyl methacrylate analogs illustrative examples of which include methyl methacrylate, ethyl methacrylate, propyl methacrylate, iso-propyl methacrylate, butyl methacrylate, hexyl methacrylate, and decyl methacrylate.

Examples of such polymers include, but are not limited to, a styrene/methylmethacrylate copolymer or a styrene/acrylonitrile/methylmethacrylate terpolymer. These copolymers may be used for the rigid thermoplastic phase either individually or as mixtures. The rigid thermoplastic phase may comprise 10 to 80 wt % methylmethacrylate, based on the total weight of the copolymer. Within this range the amount of methylmethacrylate can be greater than or equal to 20 wt %, or, more specifically greater than or equal to 30 wt %. Also within this range the amount of methylmethacrylate can be less than or equal to 70 wt %, or, more specifically less than or equal to 65 wt %. The styrene to acrylonitrile weight ratio can be 1:1 to 10:1. Within this range the styrene to acrylonitrile weight ratio can be 1.5:1 to 5:1, or, more specifically, 1.5:1 to 3:1.

In some embodiments the rigid thermoplastic phase comprises one or more vinyl aromatic polymers. Suitable vinyl aromatic polymers comprise at least about 20 wt. % structural units derived from one or more vinyl aromatic monomers. An exemplary rigid thermoplastic phase comprises a vinyl aromatic polymer having structural units derived from one or more vinyl aromatic monomers; structural units derived from one or more monoethylenic ally unsaturated nitrile monomers; and structural units derived from one or more (C₁-C₁₂)alkyl(meth)acrylate monomers. Examples of such vinyl aromatic polymers include, but are not limited to, styrene/acrylonitrile/methyl methacrylate copolymer and alpha-methylstyrene/acrylonitrile/methyl methacrylate copolymer. These copolymers may be used for the rigid thermoplastic phase either individually or as mixtures.

When structural units in rigid thermoplastic phase are derived from one or more monoethylenically unsaturated nitrile monomers, then the amount of structural units derived from nitrile monomer is 5 to 40 wt %, based on the total weight of the rigid thermoplastic phase. Within this range the nitrile monomer content can be greater than or equal to 10, or greater than or equal to 15 wt %. Also within this range the nitrile monomer content can be less than or equal to 30 wt %.

The rigid thermoplastic phase is present in an amount of 60 wt % to 90 wt %, based on the total weight of the thermoplastic material. Within this range the amount of rigid thermoplastic material can be greater than or equal to 70 wt %. Also within this range the amount of rigid thermoplastic material can be less than or equal to 85 wt %.

The graft copolymer is formed when the rigid thermoplastic phase is polymerized in the presence of the elastomeric phase. The graft copolymer comprises rigid thermoplastic phase grafted to the elastomeric phase. Without being bound by theory it is believed that the graft copolymer forms an interphase between the discontinuous elastomeric phase and the rigid thermoplastic phase and stabilizes the distribution of the elastomeric phase in the rigid thermoplastic phase.

The graft copolymer is present in an amount greater than or equal to 5 wt % based on the total weight of the thermoplastic material. The amount of the graft copolymer can be less than or equal to 60 wt %, or less than or equal to 20 wt %, or less than or equal to 15 wt %.

The rigid thermoplastic phase may be formed solely by polymerization carried out in the presence of the elastomeric phase. Alternatively the rigid thermoplastic phase can be formed by addition of one or more separately polymerized rigid thermoplastic polymers to a rigid thermoplastic polymer that has been polymerized in the presence of the elastomeric phase. When at least a portion of separately synthesized rigid thermoplastic phase is added to compositions, then the amount of said separately synthesized rigid thermoplastic phase added is in an amount in a range of between about 30 wt. % and about 80 wt. % based on the weight of the entire composition. Two or more different elastomeric phases, each possessing a different mean particle size, may be separately employed in such a polymerization reaction and then the products blended together. In illustrative embodiments wherein such products each possessing a different mean particle size of initial elastomeric phase are blended together, then the ratios of said substrates may be in a range of about 90:10 to about 10:90, or in a range of about 80:20 to about 20:80, or in a range of about 70:30 to about 30:70. In some embodiments an elastomeric phase with smaller particle size is the major component in such a blend containing more than one particle size of initial rubber substrate.

The rigid thermoplastic phase may be made according to known processes, for example, mass polymerization, emulsion polymerization, suspension polymerization or combinations thereof, wherein at least a portion of the rigid thermoplastic phase is chemically bonded, i.e., “grafted” to the elastomeric phase via reaction with unsaturated sites present in the elastomeric phase. The grafting reaction may be performed in a batch, continuous or semi-continuous process. Representative procedures include, but are not limited to, those taught in U.S. Pat. Nos. 3,944,631; and U.S. patent application Ser. No. 08/962,458, filed Oct. 31, 1997. The unsaturated sites in the rubber phase are provided, for example, by residual unsaturated sites in those structural units of the elastomer that were derived from a graft linking monomer.

The thermoplastic material may optionally comprise additives known in the art including, but not limited to, stabilizers, such as color stabilizers, heat stabilizers, light stabilizers, antioxidants, UV screeners, and UV absorbers; flame retardants, anti-drip agents, lubricants, flow promoters and other processing aids; plasticizers, antistatic agents, mold release agents, fillers, and colorants such as dyes and pigments which may be organic, inorganic or organometallic; and like additives. Illustrative additives include, but are not limited to, silica, silicates, zeolites, titanium dioxide, stone powder, glass fibers or spheres, carbon fibers, carbon black, graphite, calcium carbonate, talc, mica, lithopone, zinc oxide, zirconium silicate, iron oxides, diatomaceous earth, calcium carbonate, magnesium oxide, chromic oxide, zirconium oxide, aluminum oxide, crushed quartz, clay, calcined clay, talc, kaolin, asbestos, cellulose, wood flour, cork, cotton and synthetic textile fibers, especially reinforcing fillers such as glass fibers, carbon fibers, and metal fibers. Often more than one additive is included, and in some embodiments more than one additive of one type is included.

The thermoplastic composition can include various additives ordinarily incorporated into polymer compositions of this type, with the proviso that the additive(s) are selected so as to not significantly adversely affect the desired properties of the thermoplastic composition, in particular the glass transition temperature of the rigid thermoplastic phase. The additives can be mixed at a suitable time during the mixing of the components for forming the composition. Additives include fillers, reinforcing agents, antioxidants, heat stabilizers, light stabilizers, ultraviolet (UV) light stabilizers, plasticizers, lubricants, mold release agents, antistatic agents, colorants such as such as titanium dioxide, carbon black, and organic dyes, surface effect additives, radiation stabilizers, flame retardants, and anti-drip agents. A combination of additives can be used, for example a combination of a heat stabilizer and ultraviolet light stabilizer. In general, the additives are used in the amounts generally known to be effective. For example, the total amount of the additives (other than any filler or reinforcing agents) can be 0.01 to 5 wt. %, based on the total weight of the thermoplastic composition.

As described above, a multitude of thermoplastic extruded material such as pellet strings or monofilaments are deposited in a preset pattern and fused to form the article. An exemplary extrusion-based additive manufacturing system includes a build chamber and supply sources. In other embodiments the manufacturing system employs a build platform that is exposed to atmospheric conditions.

The build chamber comprises a platform, gantry, and extrusion head. The platform is a platform on which the article is built, and desirably moves along a vertical z-axis based on signals provided from a computer-operated controller. The gantry is a guide rail system that is desirably configured to move the extrusion head in a horizontal x-y plane within the build chamber based on signals provided from controller. The horizontal x-y plane is a plane defined by an x-axis and a y-axis where the x-axis, the y-axis, and the z-axis are orthogonal to each other. Alternatively the platform may be configured to move in the horizontal x-y plane and the extrusion head may be configured to move along the z-axis. Other similar arrangements may also be used such that one or both of the platform and extrusion head are moveable relative to each other.

The thermoplastic composition is supplied to the extrusion head from a supply source allowing the extrusion head to deposit the thermoplastic composition as an extruded material strand to build the article. Examples of suitable average diameters for the extruded material strands range from about 1.27 millimeters (about 0.050 inches) to about 3.0 millimeters (about 0.120 inches).

In some embodiments the thermoplastic material is extruded at a temperature of 320 to 415° C. The multitude of layers are deposited at a build temperature of 85 to 225 ° C.

In some embodiments the thermoplastic material is extruded at a temperature of 200 to 450° C. and the build temperature is maintained at ambient temperature during deposition of the thermoplastic extruded material.

The thermoplastic compositions are further illustrated by the following non-limiting examples.

### EXAMPLES

The following examples use the materials shown in Table 1.

TABLE 1

| Material | Description |
|---|---|
| ABS | A styrene acrylonitrile copolymer with 16 |
| | weight percent grafted polybutadiene rubber |
| MMSABA | A methyl methacrylate styrene acrylonitrile |
| | copolymer with 17 weight percent grafted |
| | butyl acrylate rubber |

Two sample strips (76.2×127×0.8 millimeters (mm)) of the same material were stacked. An aluminum spacer (0.75 mm×2.54 mm×2.54 mm) was placed at either end of the stack. The stack was then sandwiched between two metal plates. Each metal plate was one quarter inch thick. A 3.6-4.5 kilogram (Kg) weight was placed on the stack/metal plate combination to ensure good contact between the sample strips. The stack/metal plate combination with the weight were maintained at the desired temperature for the desired period of time as shown in Tables 2 and 3. The stack/metal plate combination was then cooled. The two sample strips were then separated by peeling. Samples that could not be separated were classified as welded. The samples that could be separated were classified based on the difficulty in separating the strips—a pair of strips that were difficult to separate were described as “heavy sticking”, a pair of strips that were somewhat difficult to separate were described as “medium sticking” and a pair of strips that were fairly easy to separate were described as “weak/light sticking”.

TABLE 2

| Experimental Condition | Material | Results |
|---|---|---|
| 30 minutes @ 110° C. | ABS | Medium Sticking |
| | MMSABA | Welded |

TABLE 3

| Experimental Condition | Material | Results |
|---|---|---|
| 30 minutes @ 110° C. | ABS | Medium Sticking |
| | MMSABA | Welded |
| 30 minutes @ 104° C. | ABS | Low sticking |
| | MMSABA | Low sticking |
| 15 minutes @ 113° C. | ABS | High sticking |
| | MMSABA | Welded |

As shown in Tables 2 and 3, the examples using a thermoplastic material having an acrylate in the rigid phase demonstrated better sticking than the thermoplastic material without an acrylate in the rigid phase.

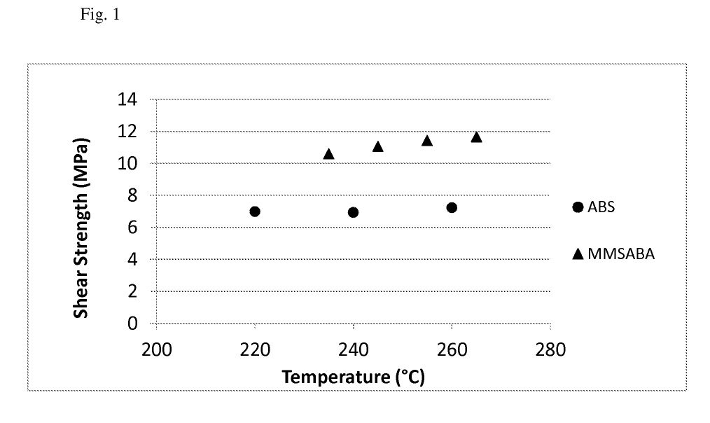

Filaments of MMSABA and filaments of ABS were extruded with a 1.75 mm target diameter. Flex bars of dimensions 76.2×9.652×6.35 mm (7×0.38×0.25 inch) were printed using material extrusion on a Makerbot printer. The bars were printed at 220, 240 and 260° C. for ABS and at 235,245,255 and 265° C. for MMSABA. Short beam shear test (ASTM D 2344) was conducted on the printed bars to evaluate interfacial strength. FIG. 1 shows the short beam shear strength of the 2 grades calculated according to the formula (0.75×peak load)/(width×thickness). The data is also shown in Table 4

TABLE 4

| | Nozzle Temperature | Shear Strength |
|---|---|---|
| Sample | (° C.) | (MPa) |
| Control (ABS) | 220 | 7.0 |
| | 240 | 6.9 |
| | 260 | 7.2 |
| Experimental (MMSABA) | 235 | 10.6 |
| | 245 | 11.1 |
| | 255 | 11.4 |
| | 265 | 11.7 |

ABS samples show lower shear strength compared to MMSABA samples indicating better interfacial adhesion between the layers for MMSABA.

### Embodiment 1

A method of making a thermoplastic article comprising: depositing a multitude of layers of thermoplastic extruded material in a preset pattern and fusing the multitude of layers of extruded material to form the article wherein the thermoplastic extruded material comprises a discontinuous elastomeric phase dispersed in a rigid thermoplastic phase wherein the rigid thermoplastic phase has structural units derived from (C₁-C₁₂)alkyl(meth)acrylate and the thermoplastic extruded material further comprises at least 5 weight percent of a graft copolymer derived from the rigid thermoplastic phase and the elastomeric phase.

### Embodiment 2

The method of Embodiment 1, wherein the elastomeric phase has a glass transition temperature less than or equal to 0° C.

### Embodiment 3

The method of Embodiment 1 or 2, wherein the (C₁-C₁₂)alkyl(meth)acrylate is methylmethacrylate.

### Embodiment 4

The method of Embodiment 1, 2 or 3, wherein the elastomeric phase comprises butyl acrylate.

### Embodiment 5

The method of Embodiment 1, 2, 3 or 4, wherein the polymer of the elastomeric phase further comprises structural units derived from at least one polyethylenically unsaturated monomer.

### Embodiment 6

The method of Embodiment 5, wherein the polyethylenically unsaturated monomer comprises butylene diacrylate, divinyl benzene, butane diol dimethacrlate, trimethylolpropane tri(meth)acrylate, allyl methacrylate, diallyl methacrylate, diallyl maleate, diallyl fumarate, diallyl phthalate, triallyl methacrylate, triallyl methacrylate, triallylisocyanurate, triallylcyanurate, the acrylate of tricyclodecenylalcohol, or a combination of the foregoing.

### Embodiment 7

The method of any of Embodiments 1-6, wherein the rigid thermoplastic phase comprises structural units derived from a vinyl aromatic monomer, a monoethylenicially unsaturated nitrile monomer, and methylmethacrylate.

### Embodiment 8

The method of Embodiment 7, wherein the rigid thermoplastic phase comprises structural units derived from styrene, acrylonitrile, and methylmethacrylate.

### Embodiment 9

The method of Embodiment 8, wherein the styrene to acrylonitrile weight ratio is 1:1 to 10:1.

### Embodiment 10

The method of Embodiment 8, wherein the styrene to acrylonitrile weight ratio is 1.5:1 to 5:1.

### Embodiment 11

The method of Embodiment 8, wherein the styrene to acrylonitrile weight ratio is 1.5:1 to 3:1.

### Embodiment 12

The method of any of Embodiments 1-11, wherein the thermoplastic extruded material comprises 10 to 35 weight percent of the elastomeric phase, based on the total weight of the thermoplastic extruded material.

### Embodiment 13

The method of any of Embodiments 1-12, wherein the rigid thermoplastic phase has a glass transition temperature of 25 to 105° C.

### Embodiment 14

The method of any of Embodiments 1-13, wherein the rigid thermoplastic phase has a glass transition temperature of 75 to 105° C.

### Embodiment 15

The method of any of Embodiments 1-14, wherein the rigid thermoplastic phase is present in an amount of 60 to 90 weight percent, based on the total weight of the thermoplastic composition.

### Embodiment 16

The method of any of Embodiments 1-15, wherein the graft copolymer is present in an amount of 5 to 15 wt %, based on the total weight of the thermoplastic material.

### Embodiment 17

The method of Embodiment 1, wherein the rigid thermoplastic phase comprises 10 to 80 wt % methylmethacrylate, based on the total weight of the copolymer.

### Embodiment 18

The method of any of Embodiments 1-17, wherein the rigid thermoplastic phase comprises 20 to 70 wt % methylmethacrylate, based on the total weight of the copolymer.

### Embodiment 19

The method of any of Embodiments 1-18, wherein the rigid thermoplastic phase comprises 30 to 65 wt % methylmethacrylate, based on the total weight of the copolymer.

In general, the invention may alternately comprise, consist of, or consist essentially of, any appropriate components herein disclosed. The invention may additionally, or alternatively, be formulated so as to be devoid, or substantially free, of any components, materials, ingredients, adjuvants or species used in the prior art compositions or that are otherwise not necessary to the achievement of the function and/or objectives of the present invention.

All ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.). “Combination” is inclusive of blends, mixtures, alloys, reaction products, and the like. Furthermore, the terms “first,” “second,” and the like, herein do not denote any order, quantity, or importance, but rather are used to denote one element from another. The terms “a” and “an” and “the” herein do not denote a limitation of quantity, and are to be construed to cover both the singular and the plural, unless otherwise indicated herein or clearly contradicted by context. The suffix “(s)” as used herein is intended to include both the singular and the plural of the term that it modifies, thereby including one or more of that term (e.g., the film(s) includes one or more films). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A method of making a thermoplastic article comprising:
depositing a multitude of layers of thermoplastic extruded material in a preset pattern and fusing the multitude of layers of extruded material to form the article wherein the thermoplastic extruded material comprises a discontinuous elastomeric phase dispersed in a rigid thermoplastic phase wherein the rigid thermoplastic phase has structural units derived from (C₁-C₁₂)alkyl(meth)acrylate and the thermoplastic extruded material further comprises at least 5 weight percent of a graft copolymer derived from the rigid thermoplastic phase and the elastomeric phase.

2. The method of claim 1, wherein the elastomeric phase has a glass transition temperature less than or equal to 0° C.

3. The method of claim 1, wherein the (C₁-C₁₂)alkyl(meth)acrylate is methylmethacrylate.

4. The method of claim 1, wherein the elastomeric phase comprises butyl acrylate.

5. The method of claim 1, wherein the polymer of the elastomeric phase further comprises structural units derived from at least one polyethylenically unsaturated monomer.

6. The method of claim 5, wherein the polyethylenically unsaturated monomer comprises butylene diacrylate, divinyl benzene, butane diol dimethacrlate, trimethylolpropane tri(meth)acrylate, allyl methacrylate, diallyl methacrylate, diallyl maleate, diallyl fumarate, diallyl phthalate, triallyl methacrylate, triallyl methacrylate, triallylisocyanurate, triallylcyanurate, the acrylate of tricyclodecenylalcohol, or a combination of the foregoing.

7. The method of claim 1, wherein the rigid thermoplastic phase comprises structural units derived from a vinyl aromatic monomer, a monoethylenicially unsaturated nitrile monomer, and methylmethacrylate.

8. The method of claim 7, wherein the rigid thermoplastic phase comprises structural units derived from styrene, acrylonitrile, and methylmethacrylate.

9. The method of claim 8, wherein the styrene to acrylonitrile weight ratio is 1:1 to 10:1.

10. The method of claim 8, wherein the styrene to acrylonitrile weight ratio is 1.5:1 to 5:1.

11. The method of claim 8, wherein the styrene to acrylonitrile weight ratio is 1.5:1 to 3:1.

12. The method of claim 1, wherein the thermoplastic extruded material comprises 10 to 35 weight percent of the elastomeric phase, based on the total weight of the thermoplastic extruded material.

13. The method of claim 1, wherein the rigid thermoplastic phase has a glass transition temperature of 25 to 105° C.

14. The method of claim 1, wherein the rigid thermoplastic phase has a glass transition temperature of 75 to 105° C.

15. The method of claim 1, wherein the rigid thermoplastic phase is present in an amount of 60 to 90 weight percent, based on the total weight of the thermoplastic composition.

16. The method of claim 1, wherein the graft copolymer is present in an amount of 5 to 15 wt %, based on the total weight of the thermoplastic material.

17. The method of claim 1, wherein the rigid thermoplastic phase comprises 10 to 80 wt % methylmethacrylate, based on the total weight of the copolymer.

18. The method of claim 1, wherein the rigid thermoplastic phase comprises 20 to 70 wt % methylmethacrylate, based on the total weight of the copolymer.

19. The method of claim 1, wherein the rigid thermoplastic phase comprises 30 to 65 wt % methylmethacrylate, based on the total weight of the copolymer.
